(19) United States
(12) Patent Application Publication
(10) Pub. No.: US 2009/0196149 A1
(43) Pub. Date: Aug. 6, 2009

(54) Optical pickup apparatus

(76) Inventors: Yuichi Atarashi, Tokyo (JP); Kohei Ota, Tokyo (JP); Junji Hashimura, Kanagawa (JP); Kiyono Ikenaka, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/663,431

(22) PCT Filed: Nov. 6, 2006
(86) PCT No.: PCT/JP06/22088

§ 371 Date: Mar. 21, 2007

(30) Foreign Application Priority Data
Nov. 8, 2005 (JP) 2005-323297

(51) Int. Cl. G11B 7/00

(52) U.S. Cl. 369/112.23; G9B/7

(57) ABSTRACT

In order to provide an optical pickup apparatus that has a relatively simple configuration and that can carry out recording and/or reproduction of information in a s compatible manner for different optical information storage medium, the optical surface of the first objective lens OBJ1 is formed only by a refracting surface, and hence it is possible to form it at a low cost even if it is made of glass. In addition, said first objective lens OBJ1 can be designed by optimizing it for the first light flux with the wavelength λ1 and the protective substrate t1 of said first optical disk OD1. On the other hand, while the second objective lens OBJ2 is used commonly for both the first light flux with a wavelength λ1 and the second light flux with a wavelength λ2, when the protective substrate t2 of the second optical disk OD2 and the protective substrate t3 of the third optical disk OD3 are the same, there is no need to consider the difference in the thickness of the protective substrate, and hence the design is easy and it is possible to produce at a low cost.

### TECHNICAL FIELD

The present invention relates to optical pickup apparatuses, and particularly to optical pickup apparatuses that can record and/or reproduce information in different optical information recording media.

### BACKGROUND ART

In recent years, in optical pickup apparatuses, the wavelength of the laser light is becoming progressively shorter in the laser light source used as the light source for reproducing the information recorded in optical disks or for recording information in optical disks, and for example, laser light sources of wavelengths of 400 nm to 420 nm are being realized such as blue-violet semiconductor lasers, blue SHG laser using wavelength conversion of infrared laser source using the second harmonic wave, etc.

If these blue-violet laser light sources are used, in the case in which an objective lens with the same numerical aperture (NA) as a DVD (Digital Versatile Disk), for an optical disk with a diameter of 12 cm, recording of 5 GB to 20 GB of information is possible, and when the NA of the objective lens is increased to 0.85, for an optical disk with a diameter of 12 cm, recording of 23 GB to 25 GB of information becomes possible. In the following, in the present patent specification, optical disks and magneto-optical disks using a blue-violet laser light source are collectively called “High Density Optical Disks”.

By the way, two standards have been proposed for high density optical disks at present. One is the Blu-ray disk (hereinafter abbreviated as BD) which uses an objective lens of an NA of 0.85 and has a protective substrate thickness of 0.1 mm, and the other is the HD DVD (hereinafter abbreviated as HD) which uses an objective lens of an NA of 0.65 to 0.67 and has a protective substrate thickness of 0.6 mm. Further, at present, DVDs or CDs with various types of information recorded in them are being marketed. In view of this current state of affairs, optical pickup apparatuses that carry out recording and/or reproduction of information for different optical disks have been proposed in Patents Documents 1 and 2.

Patent Document 1: International disclosure No. 03/91764 pamphlet

Patent Document 2: Japanese Unexamined Patent Application Publication No. 2005-209299

### DISCLOSURE OF INVENTION

### Problems to be Solved by the Invention

However, since the thicknesses of the protective substrate provided on the information recording surface of BD, HD and DVD, and CD are different being t1=0.1 mm, t2=t3=0.6 mm, and t4=1.2 mm, respectively, if the specifications are determined so that converging is done optimally for any one of the optical disks using a common objective lens, in the converging for other optical disks, there is the problem that spherical aberration occurs that is caused by the thickness of the protective substrate. For this, at the time of carrying out information recording and/or reproduction for different optical disks, since it is possible to use light flux of different wavelengths, by providing a light path difference according to the wavelength using an optical path difference causing structure formed in the objective lens, it is possible to correct for the spherical aberration caused by the thickness of the protective substrate. However, an optical path difference causing structure typified by a diffraction structure is one that forms very fine steps according to the wavelength of the incident light flux, and if this is provided on an objective optical element made of glass, there is the problem that it increases the cost.

On the other hand, when an objective optical element is formed using a plastic, by preparing a mold having very fine steps and then carrying out extrusion forming, etc., using that mold, it is possible to mass manufacture relatively easily an objective optical element having a diffraction structure. However, when an objective optical element is formed using a plastic, since in general the changes in the refractive index with respect to changes in the temperature are high, there are cases when it is difficult to use in optical pickup apparatuses in which the environmental temperature changes by a large amount.

The present invention was made in view of these problems, and the purpose of the present invention is to provide an optical pickup apparatus that has a relatively simple configuration and can record and/or reproduce information with compatibility possible with different optical information recording media.

### Means to Solve the Problems

An optical pickup apparatus described in Claim 1 comprises:

a first light source to emit a light flux with a wavelength λ1;

a second light source to emit a light flux with a wavelength λ2 (λ1<λ2);

a coupling lens placed in a common light path through which pass said first light flux and said second light flux;

a first objective optical element provided with an optical surface consisting of a refractive surface;

a second objective optical element provided with an optical surface consisting of a refractive surface;

wherein said first light flux with the wavelength λ1 emitted from the first light source can pass through the coupling lens, can be converged by the first objective optical element, and can form a converged light spot on an information recording surface of a first optical information recording medium with a protective substrate thickness of t1, and the first light flux of the wavelength λ1 emitted from the first light source can pass through the coupling lens, can be converged by the second objective optical element, and can form a converged light spot on an information recording surface of a second optical information recording medium with a protective substrate thickness of t2 (t2>t1), and also, said second light flux with the wavelength λ2 emitted from the second light source can pass through the coupling lens, can be converged by the second objective optical element, and can form a converged light spot on the information recording surface of a third optical information recording medium with a protective substrate thickness of t3 (0.9t2≦t3≦1.1t2) and also has a larger track pitch than the second information recording medium;

wherein the coupling lens can be displaced in at least three positions in a direction of an optical axis, where the first position is a position of forming a converged light spot on the information recording surface of the first optical information recording medium using said first light flux via the first objective optical element, the second position is a position of forming a converged light spot on the information recording surface of the second optical information recording medium using said first light flux via the second objective optical element, and the third position is a position of forming a converged light spot on the information recording surface of the third optical information recording medium using said second light flux via the second objective optical element; and

wherein when a parallel light flux with a wavelength λ3 (1.7λ1≦λ3≦2.3λ1) is made to be incident on the second objective optical element, the wavefront aberration is 0.07λ3rms or more in the converged light spot formed on an information recording surface of a fourth optical information recording medium with a protective substrate thickness of t4 (t4>t3) and also has a larger track pitch than the third information recording medium.

In the present invention, by forming the optical surfaces of said first objective optical element and of said second objective optical element only with refractive surfaces, the formation can be done at a low cost even if it is made of glass. In addition, since said first objective optical element can be designed by optimizing it for said first light flux and the protective substrate t1 of said first optical information recording medium, it is possible to carry out appropriately information recording and/or reproduction in said first optical information recording medium. On the other hand, while said second objective optical element is used commonly for both said first light flux and said second light flux, when the protective substrate t2 of said second optical information recording medium and the protective substrate t3 of said third optical information recording medium are the same, since there is no need to consider the difference in the thickness of the protective substrate, the design is easy and it is possible to make this a low cost one. Further, the chromatic aberration based on the difference in the wavelengths of said first light flux and said second light flux can be corrected appropriately by changing the divergence angle to said second objective optical element by displacing said coupling lens to either of said second position and said third position.

In the optical pickup apparatus described in Claim 2, in the invention described in Claim 1, since the feature is that at least one among said first to said third optical information recording medium has a plurality of information recording surfaces, and said coupling lens, according to the information recording surface on which light is converged by said objective optical element, is displaced in the direction of the optical axis, it is possible to carry out information recording and/or reproduction appropriately even for an optical information recoding medium in which the information recording surface is provided on a plurality of layers.

An optical pickup apparatus described in Claim 3 comprises: a first light source to emit a light flux with a wavelength λ1;

a second light source to emit a light flux with a wavelength λ2 (λ1<λ2);

a coupling lens that is placed in a common light path through which pass said first light flux and said second light flux and that is provided with a diffraction structure with an emission angle when the light flux with the wavelength λ1 is passed is different from the emission angle when the light flux with the wavelength λ2 is passed;

an aberration correction mechanism that is placed in the common light path and that makes the amount of spherical aberration when the light flux with the wavelength λ1 is passed different from the amount of spherical aberration when the light flux with the wavelength λ2 is passed;

a first objective optical element provided with an optical surface consisting of a refracting surface;

a second objective optical element provided with an optical surface consisting of a refractive surface;

wherein said first light flux with the wavelength λ1 emitted from the first light source can pass through the coupling lens and the aberration correction mechanism, can be converged by the first objective optical element, and can form a converged light spot on an information recording surface of a first optical information recording medium with a protective substrate thickness of t1, and the first light flux with the wavelength λ1 emitted from the first light source can pass through the coupling lens and the aberration correction mechanism, can be converged by the second objective optical element, and can form a converged light spot on an information recording surface of a second optical information recording medium with a protective substrate thickness of t2 (t2>t1), and also, said second light flux with the wavelength λ2 emitted from the second light source can pass through the coupling lens and the aberration correction mechanism, can be converged by the second objective optical element, and can form a converged light spot on an information recording surface of a third optical information recording medium with a protective substrate thickness of t3 (0.9t2≦t3≦1.1t2) and also has a larger track pitch than the second information recording medium;

wherein in the light flux that has passed through the coupling lens and the aberration correction mechanism can be given at least one among—a first aberration state suitable for forming a converged light spot on the information recording surface of the first optical information recording medium using said first light flux via the first objective optical element, a second aberration state suitable for forming a converged light spot on the information recording surface of the second optical information recording medium using said first light flux via the second objective optical element, and a third aberration state suitable for forming a converged light spot on the information recording surface of the third optical information recording medium using said second light flux via the second objective optical element; and

wherein, when a parallel light flux with a wavelength λ3 (1.7λ1≦λ3≦2.3λ1) is made to be incident on the second objective optical element, the wavefront aberration is 0.07λ3rms or more in a converged light spot formed on an information recording surface of a fourth optical information recording medium that has a protective substrate thickness of t4 (t4>t3) and also has a larger track pitch than the third information recording medium.

In the present invention, by forming the optical surfaces of said first objective optical element and of said second objective optical element only with refractive surfaces, the formation can be done at a low cost even if it is made of glass. In addition, since said first objective optical element can be designed by optimizing for said first light flux and the protective substrate t1 of said first optical information recording medium, it is possible to carry out appropriately information recording and/or reproduction in said first optical information recording medium. On the other hand, while said second objective optical element is used commonly for both said first light flux and said second light flux, when the protective substrate t2 of said second optical information recording medium and the protective substrate t3 of said third optical information recording medium are the same, since there is no need to consider the difference in the thickness of the protective substrate, the design is easy and it is possible to make this a low cost one. Further, the chromatic aberration based on the difference in the wavelengths of said first light flux and said second light flux can be corrected appropriately, in the light flux that has passed through said coupling lens and said aberration correction mechanism, by applying either said second aberration state or said third aberration state. In addition, the aberration correction mechanism can also be one that corrects other factors. The other factors, for example, can be a configuration that desirably carries out the correction of aberration caused by the difference in the oscillation wavelength of individual laser diodes due to the manufacturing lot (the so called wavelength characteristics) or due to the temperature rising with use (the temperature correction).

An optical pickup apparatus described in Claim 4 comprises: a first light source to emit a light flux with a wavelength λ1;

a second light source to emit a light flux with a wavelength λ2 (λ1<λ2);

a coupling lens that is placed in the common light path through which pass said first light flux and said second light flux;

an aberration correction mechanism that is placed in the common optical path and that makes an amount of spherical aberration when a light flux with the wavelength λ1 is passed different from an amount of spherical aberration when a light flux with the wavelength λ2 is passed;

a first objective optical element provided with an optical surface consisting of a refractive surface;

a second objective optical element provided with an optical surface having a diffraction structure in which the emission angle when a light flux with the wavelength λ1 is passed is different from the emission angle when a light flux with the wavelength λ2 is passed;

wherein said first light flux with the wavelength λ1 emitted from the first light source can pass through the coupling lens and the aberration correction mechanism, can be converged by the first objective optical element, and can form a converged light spot on an information recording surface of a first optical information recording medium with a protective substrate thickness of t1, and further the first light flux with the wavelength λ1 emitted from the first light source can pass through the coupling lens and the aberration correction mechanism, can be converged by the second objective optical element, and can form a converged light spot on the information recording surface of a second optical information recording medium with a protective substrate thickness of t2 (t2>t1), and also, said second light flux with the wavelength λ2 emitted from the second light source can pass through the coupling lens and the aberration correction mechanism, can be converged by the second objective optical element, and can form a converged light spot on an information recording surface of a third optical information recording medium with a protective substrate thickness of t3 (0.9t2≦t3≦1.1t2) and also has a larger track pitch than the second information recording medium;

wherein in the light flux that has passed through the coupling lens and the aberration correction mechanism can be given at least one among—a first aberration state suitable for forming a converged light spot on the information recording surface of the first optical information recording medium using said first light flux via the first objective optical element, a second aberration state suitable for forming a converged light spot on the information recording surface of the second optical information recording medium using said first light flux via the second objective optical element, and a third aberration state suitable for forming a converged light spot on the information recording surface of the third optical information recording medium using said second light flux via the second objective optical element; and

wherein when a parallel light flux with a wavelength λ3 (1.7λ1≦λ3≦2.3λ1) is made to be incident on the second objective optical element, the wavefront aberration is 0.07λ3rms or more in the converged light spot formed on an information recording surface of a fourth optical information recording medium that has a protective substrate thickness of t4 (t4>t3) and also has a larger track pitch than the third information recording medium.

In the present invention, by forming the optical surface of said first objective optical element only with a refractive surface, the formation can be done at a low cost even if it is made of glass. In addition, since said first objective optical element can be designed by optimizing for said first light flux and the protective substrate t1 of said first optical information recording medium, it is possible to carry out appropriately information recording and/or reproduction in said first optical information recording medium. On the other hand, while said second objective optical element is used commonly for both said first light flux and said second light flux, when the protective substrate t2 of said second optical information recording medium and the protective substrate t3 of said third optical information recording medium are the same, since there is no need to consider the difference in the thickness of the protective substrate, the design is easy and it is possible to make this a low cost one. Further, the chromatic aberration based on the difference in the wavelengths of said first light flux and said second light flux can be corrected by the diffraction structure provided in said second objective optical element. In addition, in the light flux that has passed through said coupling lens and said aberration correction mechanism, by applying either said second aberration state or said third aberration state, it is possible to make a more appropriate light flux to be incident. In addition, the coupling lens and the aberration correction mechanism can also be ones that correct other factors. The other factors, for example, can be a configuration that desirably carries out the correction of aberration caused by the difference in the oscillation wavelength of individual laser diodes due to the manufacturing lot (the so called wavelength characteristics) or due to the temperature rising with use (the temperature correction).

In the optical pickup apparatus described in Claim 5, in the invention described in Claim 3 or Claim 4, since the feature is that said aberration correction mechanism includes a section for displacing said coupling lens in the direction of the optical axis, by displacing said coupling lens in the direction of the optical axis, it is possible to generate any one of said second state and said third state.

In the optical pickup apparatus described in Claim 6, in the invention described in Claim 4 or Claim 5, since the feature is that at least one among said first to said third optical information recording medium has a plurality of information recording surfaces, and said coupling lens, according to the information recording surface on which light is converged by said objective optical element, is displaced in the direction of the optical axis, it is possible to carry out information recording and/or reproduction appropriately even for an optical information recoding medium in which the information recording surface is provided on a plurality of layers.

In the optical pickup apparatus described in Claim 7, in the invention described in Claim 3 or Claim 4, since the feature is that said aberration correction mechanism includes a liquid crystal element, by appropriately driving said liquid crystal element, it is possible to generate any one of said second state and said third state. A “liquid crystal element” is one that gives a prescribed aberration state to the light flux that is passing through it by driving it by supplying electric power to it from an external source, and has been described, for example, in Japanese Unexamined Patent Application Publication No. 2004-192719.

In the optical pickup apparatus described in Claim 8, in the invention described in Claim 7, since the feature is that at least one among said first to said third optical information recording medium has a plurality of information recording surfaces, and said liquid crystal element is driven so that it gives different aberration state to the spot converged on to the information recording surface by said objective optical element, it is possible to carry out information recording and/or reproduction appropriately even for an optical information recoding medium in which the information recording surface is provided on a plurality of layers.

In the optical pickup apparatus described in Claim 9, in the invention described in any one of Claim 1 to Claim 8, the feature is that the refractive surface of said second objective optical element has been optimized for information recording and/or reproduction with respect to said second optical information recording medium. At the time of carrying out information recording and/or reproduction with respect to said third optical information recording medium, it is possible to correct the wavefront aberration suitably using said coupling lens or said aberration correction mechanism.

In the optical pickup apparatus described in Claim 10, in the invention described in any one of Claim 1 to Claim 8, the feature is that the refractive surface of said second objective optical element has been optimized for information recording and/or reproduction with respect to said third optical information recording medium. At the time of carrying out information recording and/or reproduction with respect to said second optical information recording medium, it is possible to correct the wavefront aberration suitably using said coupling lens or said aberration correction mechanism.

In the optical pickup apparatus described in Claim 11, in the invention described in any one of Claim 1 to Claim 8, the feature is that the refractive surface of said second objective optical element has been optimized for information recording and/or reproduction with respect to a hypothetical optical information recording medium that is different from said second optical information recording medium or said third optical information recording medium. At the time of carrying out information recording and/or reproduction with respect to said second optical information recording medium or with respect to said third optical information recording medium, it is possible to correct the wavefront aberration suitably using said coupling lens or said aberration correction mechanism, and also possible to suppress the amount of correction to a small value.

In the optical pickup apparatus described in Claim 12, in the invention described in any one of Claim 1 to Claim 11, since the feature is that either one of said first objective optical element and said second objective optical element has been inserted selectively in said common optical path, it is possible to simplify the optical path configuration.

In the optical pickup apparatus described in Claim 13, in the invention described in any one of Claim 1 to Claim 11, since the feature is that, by using a selection switching element placed in said common optical path, a light flux of said wavelength λ1 is impinged on to either one of said first objective optical element and said second objective optical element, it is possible to make unnecessary a movable section for selecting said objective optical elements.

In the optical pickup apparatus described in Claim 14, in the invention described in any one of Claim 1 to Claim 13, the feature is that said coupling lens is a beam expander or a collimator lens.

In the optical pickup apparatus described in Claim 15, in the invention described in any one of Claim 3 to Claim 14, since the feature is that, when a light flux of wavelength λ1 passes through said diffraction structure, the intensity of the second order diffracted light becomes the highest, and when a light flux of wavelength λ2 passes through said diffraction structure, the intensity of the first order diffracted light becomes the highest, it is possible to make the emission angle different according to the wavelength.

In the optical pickup apparatus described in Claim 16, in the invention described in any one of Claim 3 to Claim 14, since the feature is that, when a light flux of wavelength λ1 passes through said diffraction structure, the intensity of the zero order diffracted light becomes the highest, and when a light flux of wavelength λ2 passes through said diffraction structure, the intensity of the first order diffracted light becomes the highest, it is possible to make the emission angle different according to the wavelength.

In the optical pickup apparatus described in Claim 17, in the invention described in any one of Claim 1 to Claim 16, the feature is that, the track pitch TP1 in the information recording surface of said first optical information recording medium, the track pitch TP2 in the information recording surface of said second optical information recording medium, and the track pitch TP3 in the information recording surface of said third optical information recording medium satisfy the following relationship.

TP1<TP2<TP3 (1)

In the optical pickup apparatus described in Claim 18, in the invention described in any one of Claim 1 to Claim 17, since the feature is that the reflected light from the information recording surfaces of said first to third optical information recording medium are incident on a common optical detector, it is possible to simplify the configuration of the optical pickup apparatus.

In the optical pickup apparatus described in Claim 19, in the invention described in any one of Claim 1 to Claim 18, the feature is that at least one of said first objective optical element and said second objective optical element is made of glass.

In the present patent specification, an objective optical element is, in a limited sense, in the state when an optical information recording medium is loaded in the optical pickup apparatus, refers to the element having a light converging action and placed at a position closest to the side of the optical information recording medium so as to be opposite to it.

### EFFECTS OF THE INVENTION

According to the present invention, it is possible to provide an optical pickup apparatus that has a relatively simple configuration, and can carry out recording and/or reproduction of information in a compatible manner with different optical information recording medium.

### BRIEF DESCRIPTION OF THE DRAWINGS

FIG. 1 is an outline cross-sectional view diagram of an optical pickup apparatus according to a first preferred embodiment.

FIG. 2 is an outline cross-sectional view diagram of an optical pickup apparatus according to a second preferred embodiment.

FIG. 3 is an outline perspective view diagram of the lens holder drive section.

### DESCRIPTIONS OF SYMBOLS

ACT Actuator
ACTB Actuator base
BS Beam shaper
CL1 First collimator lens
CL2 Second collimator lens
COL Coupling lens
DP1 First dichroic prism
EXP Beam expander
G Diffraction grating
LH Lens holder
LD1 First semiconductor laser
LD2 Second semiconductor laser
MGA, MGB, MGC, MGD Magnets
OBJ1 First objective lens
OBJ2 Second objective lens
OD1 First optical disk
OD2 Second optical disk
OD3 Third optical disk
OU Lens unit
PBS Polarizing beam splitter
PD Optical detector
QWP Quarter wavelength (λ/4) plate
SH Supporting shaft
SL Sensor lens
TA Tracking actuator
TCA, TCB Tracking coils
TGA Magnet
TGC Magnet
TP1 Track pitch
TP2 Track pitch
TP3 Track pitch

### BEST MODE FOR CARRYING OUT THE INVENTION

In the following, some preferred embodiments of the present invention are explained in detail referring to the drawings.

### First Embodiment

To begin with, the invention related to Claim 1 is described here.

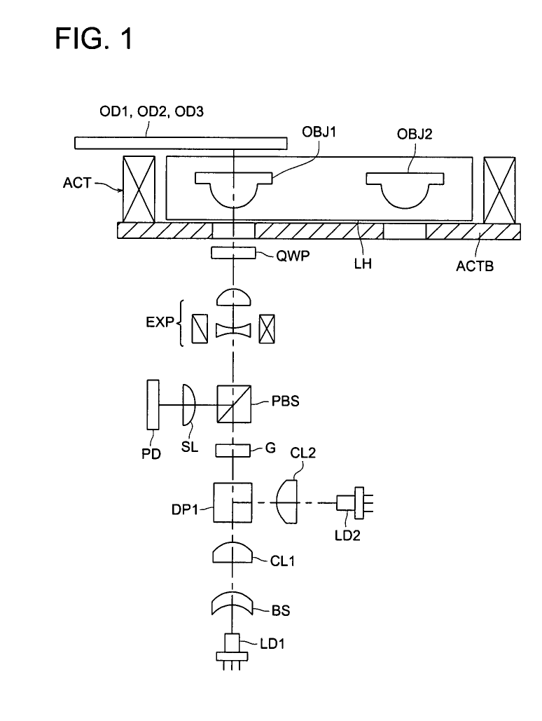

FIG. 1 is an outline cross-sectional view diagram of an optical pickup apparatus according to a first preferred embodiment which carries out recording/reproduction of information for all of the first optical disk OD1 which is a BD, the second optical disk OD2 which is an HD, and the third optical disk OD3 which is a conventional DVD. The track pitch TP1 of BD, the track pitch TP2 of HD, and the track pitch TP3 of DVD satisfy the following relationship.

TP1<TP2<TP3 (1)

As is shown in FIG. 1, the lens holder LH that retains the first objective lens (also called the first objective optical element) OBJ1 and the second objective lens (also called the second objective optical element) OBJ2, both of which are made of glass, is supported in a manner so that it is movable in at least two dimensions by the actuator ACT. The actuator ACT is affixed via an actuator base ACTB so that its position can be adjusted relative to the frame (not shown in the figure) of the optical pickup apparatus. The actuator base ACTB is supported so that it can be moved in the left and right directions in the figure by an actuator not shown in the figure.

Here, when a parallel flux of light with a wavelength of λ3 (λ3=700 nm to 800 nm) is made to be incident on the second objective lens OBJ2, the wavefront aberration will be 0.07λ3rms in the converged light spot formed on the information recording surface of a CD which is a fourth information recording disk having a protective substrate thickness of t4 (t4=1.2 mm) and also has a larger track pitch than a DVD. In other words, in this optical pickup apparatus, it is not possible to carry out recording and/or reproduction of information appropriately for a CD, but instead, the optical system and the drive system have been simplified.

Of course, even if the second objective lens is used, by making large the drive distance in the direction of the optical axis of the movable element of the beam expander EXP which is an aberration correction mechanism, it is possible to form, in theory, a converged light spot on the information recording surface of a CD. However, because the drive distance becomes large, the entire pickup apparatus becomes large in size. In addition, since limited divergent rays enter the second objective lens, and coma aberration is generated largely for the image height during tracking (inclined incidence of light flux), and hence cannot stand use in reality. Further, since it is necessary to provide a filter or to provide a diffraction structure for narrowing the light flux, this invites a cost increase.

The case of carrying out recording and/or reproduction of information for a first optical disk OD1 is explained here. In this case, it is considered that the actuator base ACTB is moved by an actuator not shown in the figure, and the optical axis of the first objective lens OBJ1 is made to match with the optical axis of the quarter wavelength (λ/4) plate QWP. In addition, the movable element of the beam expander EXP which is the coupling lens is moved to the first position along the optical axis. In FIG. 1, the light flux emitted from the first semiconductor laser LD1 (wavelength λ1=380 nm to 450 nm) as the first light source has its shape corrected by being passed through a beam shaper BS, and is made to be incident on a first collimator lens CL1 and becomes a parallel light flux. The light flux emitted from the first collimator lens CL1 is passed through a dichroic prism DP1, is passed through the diffraction grating G which is an optical section for separating the light flux emitted from the light source into a main flux for recording and reproduction and a sub flux for tracking error signal detection, and is further passed through a polarized beam splitter PBS and a beam expander EXP.

The parallel light flux that has passed through the beam expander EXP is passed through a quarter wavelength (λ/4) plate QWP, converged by the first objective lens OBJ1, and, via the protective substrate (thickness t1=0.1 mm) of the first optical disk OD1, is converged on its information recording surface and forms a converged light spot there.

Next, since the light flux that is modulated and reflected by the information pit in the information recording surface again passes through the first objective lens OBJ1, the quarter wavelength (λ/4) plate QWP, and the beam expander EXP, is reflected by the polarized beam splitter PBS, subsequently passes through the sensor lens SL, and enters the light receiving surface of the optical detector PD, using the output signal of which the read out signal of the information recorded in the first optical disk OD1 is obtained.

Further, changes in the amount of light due to changes in the shape and changes in the position of the stop on the optical detector PD are detected thereby carrying out converg detection and track detection. Based on this detection, so that the light flux from the first semiconductor laser LD1 is imaged on the information recording surface of the first optical disk OD1, the actuator ACT is driven so as to move the first objective lens OBJ1 along with the lens holder LH.

The case of carrying out recording and/or reproduction of information for a second optical disk OD2 is explained here. In this case, it is considered that the actuator base ACTB is moved by an actuator not shown in the figure, and the optical axis of the second objective lens OBJ2 is made to match with the optical axis of the quarter wavelength (λ/4) plate QWP. In addition, the movable element of the beam expander EXP which is the coupling lens is moved to the second position along the optical axis. The light flux emitted from the second semiconductor laser LD2 (wavelength λ2=600 nm to 700 nm) is incident on a second collimator lens CL2 and becomes a parallel light flux. The light flux emitted from the second collimator lens CL2 is reflected by a dichroic prism DP1, is passed through the diffraction grating G, and is further passed through a polarized beam splitter PBS and a beam expander EXP.

The parallel light flux that has passed through the beam expander EXP is passed through a quarter wavelength (λ/4) plate QWP, converged by the second objective lens OBJ2, and, via the protective substrate (thickness t2=0.6 mm) of the second optical disk OD2, is converged on its information recording surface and forms a converged light spot there.

Next, since the light flux that is modulated and reflected by the information pit in the information recording surface again passes through the second objective lens OBJ2, the quarter wavelength (λ/4) plate QWP, and the beam expander EXP, is reflected by the polarized beam splitter PBS, subsequently passes through the sensor lens SL, and enters the light receiving surface of the optical detector PD, the read out signal of the information recorded in the second optical disk OD2 is obtained using the output of this optical detector.

Further, changes in the amount of light due to changes in the shape and changes in the position of the spot on the optical detector PD are detected thereby carrying out converg detection and track detection. Based on this detection, so that the light flux from the second semiconductor laser LD2 is imaged on the information recording surface of the second optical disk OD2, the actuator ACT is driven so as to move the second objective lens OBJ2 along with the lens holder LH.

The case of carrying out recording and/or reproduction of information for a third optical disk OD3 is explained here. In this case, it is considered that the actuator base ACTB is moved by an actuator not shown in the figure, and the optical axis of the second objective lens OBJ2 is made to match with the optical axis of the quarter wavelength (λ/4) plate QWP. In addition, the movable element of the beam expander EXP which is the coupling lens is moved to the third position along the optical axis. The light flux emitted from the second semiconductor laser LD2 (wavelength λ2=600 nm to 700 nm) is incident on a second collimator lens CL2 and becomes a parallel light flux. The light flux emitted from the second collimator lens CL2 is reflected by a dichroic prism DP1, is passed through the diffraction grating G, and is further passed through a polarized beam splitter PBS and a beam expander EXP.

The light flux with a prescribed divergence angle (or a convergence angle) that has passed through the beam expander EXP is passed through a quarter wavelength (λ/4) plate QWP, converged by the second objective lens OBJ2, and, via the protective substrate (thickness t3=0.6 mm) of the third optical disk OD3, is converged on its information recording surface and forms a converged light spot there.

Next, since the light flux that is modulated and reflected by the information pit in the information recording surface again passes through the second objective lens OBJ2, the quarter wavelength (λ/4) plate QWP, and the beam expander EXP, is reflected by the polarized beam splitter PBS, subsequently passes through the sensor lens SL, and enters the light receiving surface of the optical detector PD, the read out signal of the information recorded in the third optical disk OD3 is obtained using the output of this optical detector.

Further, changes in the amount of light due to changes in the shape and changes in the position of the spot on the optical detector PD are detected thereby carrying out converg detection and track detection. Based on this detection, so that the light flux from the second semiconductor laser LD2 is imaged on the information recording surface of the third optical disk OD3, the actuator ACT is driven so as to move the second objective lens OBJ2 along with the lens holder LH.

Further, when the first optical disk OD1 to the third optical disk OD3 have a plurality of layers of information recording surfaces, by displacing the movable element of the beam expander EXP in the direction of the optical axis, it becomes possible to carry out recording and/or reproduction of information in any of the information recording surfaces.

By forming the optical surface of the first objective lens OBJ1 and the optical surface of the second objective lens OBJ2 only by a refracting surface, it is possible to form them at a low cost even if they are made of glass. In addition, since said first objective lens OBJ1 can be designed by optimizing it for the first light flux of wavelength λ1 and the protective substrate t1 of said first optical disk OD1, it is possible to carry out appropriately information recording and/or reproduction in the first optical disk OD1. On the other hand, while the second objective lens OBJ2 is used commonly for both the first light flux of wavelength λ1 and the second light flux of wavelength λ2, when the protective substrate t2 of the second optical disk OD2 and the protective substrate t3 of the third optical disk OD3 are the same, since there is no need to consider the difference in the thickness of the protective substrate, the design is easy and it is possible to make this a low cost one. Further, the chromatic aberration based on the difference in the wavelengths of said first light flux and said second light flux can be corrected appropriately by displacing the beam expander EXP, thereby changing the divergence angle to the second objective lens OBJ2.

### Second Preferred Embodiment

Next, the invention related to Claim 3 is described here.

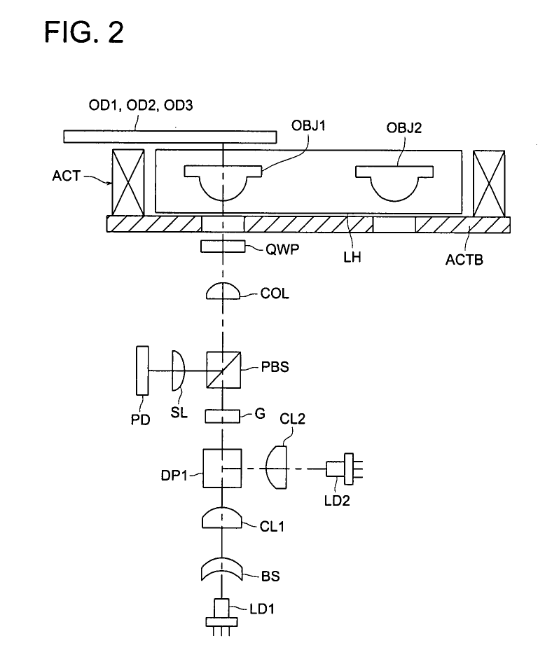

FIG. 2 is an outline cross-sectional view diagram of an optical pickup apparatus according to a second preferred embodiment which carries out recording/reproduction of information for all of the first optical disk OD1 which is a BD, the second optical disk OD2 which is an HD, and the third optical disk OD3 which is a conventional DVD. The track pitch TP1 of BD, the track pitch TP2 of HD, and the track pitch TP3 of DVD satisfy the following relationship.

TP1<TP2<TP3 (1)

As is shown in FIG. 2, the lens holder LH that retains the first objective lens (also called the first objective optical element) OBJ1 and the second objective lens (also called the second objective optical element) OBJ2, both of which are made of glass, is supported in a manner so that it is movable in at least two dimensions by the actuator ACT. The actuator ACT is affixed via an actuator base ACTB so that its position can be adjusted relative to the frame (not shown in the figure) of the optical pickup apparatus. The actuator base ACTB is supported so that it can be moved in the left and right directions in the figure by an actuator not shown in the figure. Also, a diffraction structure has been formed as an aberration correction mechanism on the optical surface of the coupling lens (or the collimator lens) so that the intensity of the second order diffracted light becomes the highest when a light flux of wavelength λ1 passes through said diffraction structure, and the intensity of the first order diffracted light becomes the highest when a light flux of wavelength λ2 passes through said diffraction structure.

Here, when a parallel flux of light with a wavelength of λ3 (λ3=700 nm to 800 nm) is made to be incident on the second objective lens OBJ2, the wavefront aberration will be 0.07λ3rms in the converged light spot formed on the information recording surface of a CD which is a fourth information recording disk having a protective substrate thickness of t4 (t4=1.2 mm) and also has a larger track pitch than a DVD. In other words, in this optical pickup apparatus, it is not possible to carry out recording and/or reproduction of information appropriately for a CD, but instead, the optical system and the drive system have been simplified.

Of course, even if the second objective lens is used, by making finer the diffraction structure which is an aberration correction mechanism, it is possible to form, in theory, a converged light spot on the information recording surface of a CD. However, because of making fine the diffraction structure, the structural complexity becomes high and also the diffraction efficiency decreases, as a result this invites a cost increase. Therefore, in order to complement the diffraction action, although it is possible to consider further a means of displacing the coupling lens (or the collimator lens) COL in the direction of the optical axis and to change the magnification of the light flux that is incident on the second objective lens OBJ2 (in concrete terms, causing limited divergence), but in this case, as a result, since a drive mechanism becomes necessary, the overall size of the pickup becomes large. In addition, since the limited divergent rays enter the second objective lens, coma aberration is generated largely for the image height during tracking (inclined incidence of light flux).

The case of carrying out recording and/or reproduction of information for a first optical disk OD1 is explained here. In this case, it is considered that the actuator base ACTB is moved by an actuator not shown in the figure, and the optical axis of the first objective lens OBJ1 is made to match with the optical axis of the quarter wavelength (λ/4) plate QWP. In FIG. 1, the light flux emitted from the first semiconductor laser LD1 (wavelength λ1=380 nm to 450 nm) as the first light source has its shape corrected by being passed through a beam shaper BS, and is made to be incident on a first collimator lens CL1 and becomes a parallel light flux. The light flux emitted from the first collimator lens CL1 is passed through a dichroic prism DP1, is passed through the diffraction grating G which is an optical section for separating the light flux emitted from the light source into a main flux for recording and reproduction and a sub flux for tracking error signal detection, and is further passed through a polarized beam splitter PBS and a coupling lens COL.

The second order diffraction light that has passed through the coupling lens COL is passed through a quarter wavelength (λ/4) plate QWP, converged by the first objective lens OBJ1, and, via the protective substrate (thickness t1=0.1 mm) of the first optical disk OD1, is converged on its information recording surface and forms a converged light spot there.

Next, since the light flux that is modulated and reflected by the information pit in the information recording surface again passes through the first objective lens OBJ1, the quarter wavelength (λ/4) plate QWP, and the coupling lens COL, is reflected by the polarized beam splitter PBS, subsequently passes through the sensor lens SL, and enters the light receiving surface of the optical detector PD, using the output signal of which the read out signal of the information recorded in the first optical disk OD1 is obtained.

Further, changes in the amount of light due to changes in the shape and changes in the position of the spot on the optical detector PD are detected thereby carrying out converg detection and track detection. Based on this detection, so that the light flux from the first semiconductor laser LD1 is imaged on the information recording surface of the first optical disk OD1, the actuator ACT is driven so as to move the first objective lens OBJ1 along with the lens holder LH.

The case of carrying out recording and/or reproduction of information for a second optical disk OD2 is explained here. In this case, it is considered that the actuator base ACTB is moved by an actuator not shown in the figure, and the optical axis of the second objective lens OBJ2 is made to match with the optical axis of the quarter wavelength (λ/4) plate QWP. The light flux emitted from the second semiconductor laser LD2 (wavelength λ2=600 nm to 700 nm) is incident on a second collimator lens CL2 and becomes a parallel light flux. The light flux emitted from the second collimator lens CL2 is reflected by a dichroic prism DP1, is passed through the diffraction grating G, and is further passed through a polarized beam splitter PBS and the coupling lens COL.

The parallel light flux that has passed through the coupling lens COL is passed through a quarter wavelength (λ/4) plate QWP, converged by the second objective lens OBJ2, and, via the protective substrate (thickness t2=0.6 mm) of the second optical disk OD2, is converged on its information recording surface and forms a converged light spot there.

Next, since the light flux that is modulated and reflected by the information pit in the information recording surface again passes through the second objective lens OBJ2, the quarter wavelength (λ/4) plate QWP, and the coupling lens COL, is reflected by the polarized beam splitter PBS, subsequently passes through the sensor lens SL, and enters the light receiving surface of the optical detector PD, the read out signal of the information recorded in the second optical disk OD2 is obtained using the output of this optical detector.

Further, changes in the amount of light due to changes in the shape and changes in the position of the spot on the optical detector PD are detected thereby carrying out converg detection and track detection. Based on this detection, so that the light flux from the second semiconductor laser LD2 is imaged on the information recording surface of the second optical disk OD2, the actuator ACT is driven so as to move the second objective lens OBJ2 along with the lens holder LH.

The case of carrying out recording and/or reproduction of information for a third optical disk OD3 is explained here. In this case, it is considered that the actuator base ACTB is moved by an actuator not shown in the figure, and the optical axis of the second objective lens OBJ2 is made to match with the optical axis of the quarter wavelength (λ/4) plate QWP. The light flux emitted from the second semiconductor laser LD2 (wavelength λ2=600 nm to 700 nm) is incident on a second collimator lens CL2 and becomes a parallel light flux. The light flux emitted from the second collimator lens CL2 is reflected by a dichroic prism DP1, is passed through the diffraction grating G, and is further passed through a polarized beam splitter PBS and the coupling lens COL.

The first order diffracted light beam that has passed through the coupling lens COL is passed through a quarter wavelength (λ/4) plate QWP, converged by the second objective lens OBJ2, and, via the protective substrate (thickness t3=0.6 mm) of the third optical disk OD3, is converged on its information recording surface and forms a converged light spot there.

Next, since the light beam that is modulated and reflected by the information pit in the information recording surface again passes through the second objective lens OBJ2, the quarter wavelength (λ/4) plate QWP, and the coupling lens COL, is reflected by the polarized beam splitter PBS, subsequently passes through the sensor lens SL, and enters the light receiving surface of the optical detector PD, the read out signal of the information recorded in the third optical disk OD3 is obtained using the output of this optical detector.

Further, changes in the amount of light due to changes in the shape and changes in the position of the spot on the optical detector PD are detected thereby carrying out converg detection and track detection. Based on this detection, so that the light beam from the second semiconductor laser LD2 is imaged on the information recording surface of the third optical disk OD3, the actuator ACT is driven so as to move the second objective lens OBJ2 along with the lens holder LH.

Further, when the first optical disk OD1 to the third optical disk OD3 have a plurality of layers of information recording surfaces, by inserting a liquid crystal element not shown in the figure in the optical path, it becomes possible to carry out recording and/or reproduction of information in any of the information recording surfaces.

By forming the optical surface of the first objective lens OBJ1 and the optical surface of the second objective lens OBJ2 only by a refracting surface, it is possible to form them at a low cost even if they are made of glass. In addition, since said first objective lens OBJ1 can be designed by optimizing it for the first light beam of wavelength λ1 and the protective substrate t1 of said first optical disk OD1, it is possible to carry out appropriately information recording and/or reproduction in the first optical disk OD1. On the other hand, while the second objective lens OBJ2 is used commonly for both the first light beam of wavelength λ1 and the second light beam of wavelength λ2, when the protective substrate t2 of the second optical disk OD2 and the protective substrate t3 of the third optical disk OD3 are the same, since there is no need to consider the difference in the thickness of the protective substrate, the design is easy and it is possible to make this a low cost one. Further, the chromatic aberration based on the difference in the wavelengths of said first light beam and said second light beam can be corrected appropriately by the diffraction structure of the coupling lens COL, thereby changing the divergence angle to the second objective lens OBJ2. In the present preferred embodiment, since there is no mechanism of driving the constituent elements of the optical system looking into the objective lens, it is possible to simplify the configuration of the optical pickup apparatus. Further, when using an optical disk having a plurality of layers of information recording surfaces, by driving appropriately the liquid crystal element placed within the optical path, it is possible to form the converged light spot on the layer to be used.

Further, in the preferred embodiment described above, it is also possible to make the optical surface of the coupling lens COL a refractive surface without providing a diffraction structure, and instead, it is possible to provide a liquid crystal element as an aberration correction mechanism. In this case, the liquid crystal element can be driven according to the first to the third optical disk to be used and it is possible to provide a different aberration state to the light beam that is passing through it. Also, in the preferred embodiment described above, although by moving the lens holder LH that holds the first objective lens OBJ1 and the second objective lens OBJ2, either of the objective lenses is being inserted into the optical path, instead it is possible to switch the optical path using a movable type mirror, etc., as a switching element, and to make the light beam pass through either of the objective lenses. It is also possible to use as the light source a so called 2-laser 1-package, etc., in which two semiconductor lasers are enclosed in one package.

### Third Preferred Embodiment

Next, the invention related to Claim 4 is described here referring again to FIG. 2.

Since the outline configuration of the pickup apparatus such as the relationships among the track pitches of the optical disks are the same as in the second preferred embodiment, their explanation is omitted here.

The third preferred embodiment is largely different from the second preferred embodiment in that a diffraction structure is provided on the optical surface of the second objective lens OBJ2. Regarding the action of this diffraction structure, the function is the same as that provided on the coupling lens (or collimator lens) COL in the second preferred embodiment.

Further, when a parallel beam of light with a wavelength of λ3 (λ3=700 nm to 800 nm) is made to be incident on the second objective lens OBJ2, the wavefront aberration will be 0.07λ3rms in the converged light spot formed on the information recording surface of a CD which is a fourth information recording disk having a protective substrate thickness of t4 (t4=1.2 mm) and also has a larger track pitch than a DVD. In other words, in this optical pickup apparatus, it is not possible to carry out recording and/or reproduction of information appropriately for a CD, but instead, the optical system and the drive system have been simplified, which aspect is the same as in the first preferred embodiment and in the second embodiment. Also, although it is similar in the point that, by making the magnification of the incident light beam of a limited divergence type, in theory it is possible to form theoretically a satisfactory converged light spot on the information recording surface of a CD, the problem that occurs when an attempt is made to realize this is similar to that described in the second preferred embodiment.

Since the case of carrying out information recording and/or reproduction for a first optical disk OD1 is the same as in the second preferred embodiment, its description will be omitted here, and only the case of carrying out information recording and/or reproduction for a second optical disk OD2 will be described here. In this case, it is considered that the actuator base ACTB is moved by an actuator not shown in the figure, and the optical axis of the second objective lens OBJ2 is made to match with the optical axis of the quarter wavelength (λ/4) plate QWP. The light beam emitted from the second semiconductor laser LD2 (wavelength λ2=600 nm to 700 nm) is incident on a second collimator lens CL2 and becomes a parallel light beam. The light beam emitted from the second collimator lens CL2 is reflected by a dichroic prism DP1, is passed through the diffraction grating G, and is further passed through a polarized beam splitter PBS and the coupling lens COL.

The parallel light beam that has passed through the coupling lens COL is passed through a quarter wavelength (λ/4) plate QWP, gets the converging effect and the diffraction effect of the second objective lens OBJ2, and, via the protective substrate (thickness t2=0.6 mm) of the second optical disk OD2, is converged on its information recording surface and forms a converged light spot there. Here, the second order diffracted light is forming the converged light spot.

Next, since the light beam that is modulated and reflected by the information pit in the information recording surface again passes through the second objective lens OBJ2, the quarter wavelength (λ/4) plate QWP, and the coupling lens COL, is reflected by the polarized beam splitter PBS, subsequently passes through the sensor lens SL, and enters the light receiving surface of the optical detector PD, the read out signal of the information recorded in the second optical disk OD2 is obtained using the output of this optical detector.

Further, changes in the amount of light due to changes in the shape and changes in the position of the spot on the optical detector PD are detected thereby carrying out converg detection and track detection. Based on this detection, so that the light beam from the second semiconductor laser LD2 is imaged on the information recording surface of the second optical disk OD2, the actuator ACT is driven so as to move the second objective lens OBJ2 along with the lens holder LH.

The case of carrying out recording and/or reproduction of information for a third optical disk OD3 is explained here. In this case, it is considered that the actuator base ACTB is moved by an actuator not shown in the figure, and the optical axis of the second objective lens OBJ2 is made to match with the optical axis of the quarter wavelength (λ/4) plate QWP. The light beam emitted from the second semiconductor laser LD2 (wavelength λ2=600 nm to 700 nm) is incident on a second collimator lens CL2 and becomes a parallel light beam. The light beam emitted from the second collimator lens CL2 is reflected by a dichroic prism DP1, is passed through the diffraction grating G, and is further passed through a polarizing beam splitter PBS and the coupling lens COL.

The light beam that has passed through the coupling lens COL is passed through a quarter wavelength (λ/4) plate QWP, gets the converging effect and the diffraction effect of the second objective lens OBJ2, and, via the protective substrate (thickness t3=0.6 mm) of the third optical disk OD3, is converged on its information recording surface and forms a converged light spot there.

Next, since the light beam that is modulated and reflected by the information pit in the information recording surface again passes through the second objective lens OBJ2, the quarter wavelength (λ/4) plate QWP, and the coupling lens COL, is reflected by the polarized beam splitter PBS, subsequently passes through the sensor lens SL, and enters the light receiving surface of the optical detector PD, the read out signal of the information recorded in the third optical disk OD3 is obtained using the output of this optical detector.

Further, changes in the amount of light due to changes in the shape and changes in the position of the spot on the optical detector PD are detected thereby carrying out converg detection and track detection. Based on this detection, so that the light beam from the second semiconductor laser LD2 is imaged on the information recording surface of the third optical disk OD3, the actuator ACT is driven so as to move the second objective lens OBJ2 along with the lens holder LH.

Further, when the first optical disk OD1 to the third optical disk OD3 have a plurality of layers of information recording surfaces, by inserting a liquid crystal element not shown in the figure in the optical path, it becomes possible to carry out recording and/or reproduction of information in any of the information recording surfaces.

By forming the optical surface of the first objective lens OBJ1 only by a refracting surface, it is possible to form it at a low cost even if it is made of glass. In addition, since said first objective lens OBJ1 can be designed by optimizing it for the first light beam of wavelength λ1 and the protective substrate t1 of said first optical disk OD1, it is possible to carry out appropriately information recording and/or reproduction in the first optical disk OD1. On the other hand, while the second objective lens OBJ2 is used commonly for both the first light beam of wavelength λ1 and the second light beam of wavelength λ2, and a diffraction structure is provided on its refractive surface, when the protective substrate t2 of the second optical disk OD2 and the protective substrate t3 of the third optical disk OD3 are the same, since there is no need to consider the difference in the thickness of the protective substrate, the design is easy and it is possible to make this a low cost one. Further, the chromatic aberration based on the difference in the wavelengths of said first light beam and said second light beam can be corrected appropriately by the diffraction structure provided on the objective lens. In the present preferred embodiment, since there is no mechanism of driving the constituent elements of the optical system looking into the objective lens, although it is possible to simplify the configuration of the optical pickup apparatus, if necessary it is also possible to make the collimator lens COL drivable. In concrete terms, in order to supplement the effect of the diffraction structure of the second objective lens OBJ2, or to prevent the diffraction structure from becoming finer, it is desirable to make the position of the coupling lens COL in the direction of the optical axis different when recording and reproduction is being done for the second optical disk OD2 than when recording and reproduction is being done for the third optical disk OD3.

Further, when it is possible to correct chromatic aberration only by the diffraction structure of the second objective lens OBJ2, it is possible to use the aberration correction mechanism to correct more desirably other factors. The other factors here, for example, can be a configuration that desirably carries out the correction of aberration caused by the difference in the oscillation wavelength of individual laser diodes due to the manufacturing lot (the so called wavelength characteristics) or due to the temperature rising with use (the temperature correction).

Further, when using an optical disk having a plurality of layers of information recording surfaces, by driving appropriately the liquid crystal element placed within the optical path, it is possible to form the converged light spot on the layer to be used.

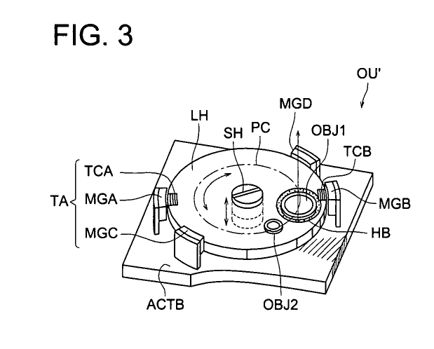

Further, in FIG. 3 is shown an outline perspective view diagram of the lens holder drive section in another embodiment. The lens unit OU′ shown in FIG. 3 can be placed in the optical pickup apparatuses of FIGS. 1 and 2, and is provided with a an objective lens OBJ1 (the first objective optical element) and an objective lens OB (the second objective optical element) which respectively converg the laser light from a semiconductor laser respectively on the information storing surfaces of different optical disks, a lens holder LH that holds the optical axes of these objective lenses OBJ1 and OBJ2 on the same circular circumference PC, an actuator base ACTB that supports this lens holder LH in a free to rotate manner via the supporting shaft SH provided at the position of the central shaft of the circumference PC and also in a manner in which it is free to make reciprocating motion along the central shaft of this rotation, a converging actuator (not shown in the figure) that moves the lens holder LH in a reciprocating manner in a direction along the supporting shaft SH, and a tracking actuator TA that carries out position of each of the objective lenses OBJ1 and OBJ2 by causing rotary motion of the lens holder LH. An operation control circuit (not shown in the figure) that controls the operations of each of the actuators is provided in this lens unit OU′.

The objective lenses OBJ1 and OBJ2 are respectively installed in holes that pierce through the flat plate surface of the circular plate shaped lens holder LH, and are placed at respectively equal distances from the center of the lens holder LH. This lens holder LH is engaged in a free to rotate manner with the top end part of the supporting shaft SH that is made to stand at its center on the actuator base ACTB, and on the bottom end of this supporting shaft SH is placed a converging actuator that is not shown in the figure.

In other words, this converging actuator constitutes an electromagnetic solenoid from the permanent magnet provided on the bottom end part of the supporting shaft and the coil provide on the periphery, and by adjusting the electric current passed through the coil, it causes reciprocating movement of the supporting shaft SH and the lens holder LH in very small units in a direction along this supporting shaft SH (the up and down directions in FIG. 3) thereby carrying out adjustment of the converging distance.

Further, as has been described before, this lens holder LH is given swinging motion by the tracking actuator TA centering on the supporting shaft SH having an axis parallel to the optical axis. This tracking actuator TA is provided with a pair of tracking coils TCA and TCB that are provided symmetrically at the edge part of the lens holder LH with the supporting shaft SH in between, and magnets MGA, MGB, MGC, and MGD that constitute two pairs and provided at symmetrical positions with the supporting shaft in the middle on the actuator base and in proximity with the edge part of the lens holder LH.

Further, the positions of the magnets MGA and MGB have been set so that, when the tracking coils TCA and TCB are respectively opposite the magnets MGA and MGB that constitute one pair, the objective lens OBJ1 is in the optical path of the laser light, and also, the positions of the magnets MGC and MGD have been set so that, when the tracking coils TCA and TCB are respectively opposite the magnets MGC and MGD that constitute one pair, the objective lens OBJ2 is in the optical path of the laser light.

Further, the lens holder LH described above is provided with stoppers not shown in the figure that restrict the range of its swinging movement so that the tracking coil TCA does not come opposite the magnet MGB or the magnet MGD and so that the tracking coil TCB does not come opposite the magnet TGA or the magnet TGC.

In addition, the tracking actuator TA is provided so that the direction of the tangential line of the outer circumference of the circular lens holder is at right angles to the tangential line of the tracks of the optical disks, and this is for correcting the shift in the position of illumination of the laser light relative to the track by giving swinging movement in very small units to this lens holder LH. Therefore, in order to carry out this tracking operation, for example, it is necessary to give a very small rotating force to the lens holder LH while maintaining each of the tracking coils TCA and TCB in a state in which they are opposite to each of the magnets MGA and MGB.

In order to carry out this tracking operation, the configuration is such that each of the tracking coils TCA and TCB are provided with iron pieces in their insides, and while these iron pieces are being attracted to each of the magnets, control of the electric currents passed through each of the tracking coils TCA and TCB is carried out by the operation control circuit so that very small repulsive force is generated between these iron pieces and each of the magnets.

Further, although the second objective lens OBJ2 can correspond to both the second optical disks (HD DVD) and the third optical disks (DVD), even in the case when it is constituted only of a refractive surface, or even in the case when it has a diffractive surface, it is possible to select appropriately the optical disk that is optimized for. When optimized for the second optical disks (HD DVD), it is sufficient to make it correspond to the third optical disks (DVD) due to the action of the aberration correction mechanism and the diffractive surface. In this case, there is the advantage that it is possible to carry out the formation of a still better converged light spot for an HD DVD. The converse is also true.

Further, the case in which a substrate thickness intermediate between the two is selected, an optical surface optimum for that substrate thickness is designed, and both the optical disks are corresponded to due to the action of the aberration correction mechanism and the diffractive surface, is desirably used in the case when a diffraction structure is provided on the objective lens, and converged light spot is formed by generating diffracted light of an order other than 0 in either case.

Example of Implementation:

Examples of implementation ideally suitable for the first preferred embodiment and the second preferred embodiment are described below.

In these preferred embodiments, it is possible to use desirably the design described in U.S. Pat. No. 6,411,442 and U.S. Pat. No. 6,512,640 both of the present patent applicants (both have priority rights in Japan, and Japanese Patent Application No. Hei 11-247394 and Hei 2000-60843) for the first objective lens OBJ1.

Further, for the second objective lens OBJ2, it is possible to use the design of Unexamined Japanese Patent Application Publication No. 2004-101823 by the present applicants.

Further, in the objective lens for HD DVD described in Unexamined Japanese Patent Application Publication No. 2004-101823, although a diffraction structure for correction of wavelength characteristics has been provided, it is possible from publicly known technology to carry out optical design with only the refractive surface but taking that this color correction function is not present.

Next, an example of implementation ideally suitable for the third preferred embodiment is described here. However, in the following (including the lens data in the tables), powers of 10 (for example, 2.5×10⁻³) are expressed using the symbol E (for example, 2.5×E−3).

The optical surfaces of objective optical systems are formed by aspherical surfaces that have axial symmetry around the optical axis as stipulated by substituting the coefficients shown in the table in Equation 1. Here, the position in the direction of the optical axis is denoted by X, the height in a direction perpendicular to the optical axis is denoted by h, the radius of curvature of the optical surface is denoted by r, the conical constant by κ, and the aspherical surface coefficient by A₂ᵢ.

$$X = \frac{{h}^{2} / r}{1 + \sqrt{1 - ( 1 + κ ) {h}^{2} / {r}^{2}}} + {\sum }_{i = 2} {A}_{2 i} {h}^{2 i} \qquad Equation 1$$

Further, when using a diffraction structure (phase structure), the optical path difference applied by it to the light beam of each wavelength is stipulated by substituting the coefficients shown in the table in the optical path difference function of Equation 2. In other words, the optical path difference function ΦB(mm) is expressed by Equation 2 when the height in a direction perpendicular to the optical axis is denoted by h, the order of diffraction by m, the wavelength used (the wavelength of the emission by the semiconductor laser) by λ, the blazed wavelength by λB, and the optical path difference function coefficient by C.

$${Φ}_{B} = m \times \frac{λ}{{λ}_{B}} \times {\sum }_{i = 1}^{5} {C}_{2 i} {h}^{2 i} \qquad Equation 2$$

The lens data (including the focal distance of the objective lens, image plane side numerical aperture, and magnification) of the first objective lens OBJ1 is shown in Table 1. The optical surface of the objective lens of Table 1 is formed only of a refractive surface.

TABLE 1
Lens data of the first objective lens
Focal distance f₁ = 2.2 mm
Image surface side numerical aperture NA1: 0.85
Magnification m1: 1/23.3

| “ith” surface | ri | di (408 nm) | ni (408 nm) |
|---|---|---|---|
| 0 | | −50 | |
| 1 | ∞ | 0.1 (φ3.65 mm) | |
| (Aperture | | | |
| diameter) | | | |
| 2 | 1.37808 | 2.60000 | 1.524461 |
| 3 | −2.48805 | 0.62 | 1.0 |
| 4 | ∞ | 0.0875 | 1.61829 |
| 5 | ∞ | | |

Aspherical data
Surface 2
Aspherical coefficient
κ = −6.6478 × E−1
A1 = +1.1830 × E−2
A2 = +2.1368 × E−3
A3 = +6.0478 × E−5
A4 = +4.1813 × E−4
A5 = −2.1208 × E−5
A6 = −2.7978 × E−5
A7 = +1.0575 × E−5
A8 = +1.8451 × E−6
A9 = −4.8060 × E−7
Surface 3
Aspherical coefficient
κ = −5.7511 × E+1
A1 = +8.1811 × E−2
A2 = −4.7203 × E−2
A3 = +9.3444 × E−3
A4 = +1.6660 × E−3
A5 = −7.2478 × E−4
Note:
“di” is the displacement from the “ith” surface to the “(i + 1)th” surface

The lens data (including the focal distance of the objective lens, image plane side numerical aperture, and magnification) of the second objective lens OBJ2 is shown in Table 2, and the aspherical data is shown in Table 3. In addition to a refractive surface, a diffraction structure is provided on the optical surface of the second objective lens. In addition, by changing the magnification of the coupling lens, a still better formation of the converged light spot is being made.

Further, as has been explained earlier, it is not possible to form an ideally suitable converged light spot for a CD. When a parallel light beam with a wavelength λ3 (λ3=700 nm to 800 nm) is incident on the second objective lens OBJ2 shown in Table 2 and Table 3, the wavefront aberration is 0.178λ3rms in the converged light spot formed on the information recording surface of a CD that has a protective substrate thickness of t4 (t4=1.2 mm) and also has a large track pitch than a DVD.

TABLE 2
Lens data of the second objective lens
Focal distance f₁ = 3.00 mm f₂ = 3.10 mm
Image surface side numerical
aperture NA1: 0.65 NA2: 0.65
Surface 2 diffraction order n1: 10 n2: 6
Surface 2′ diffraction order m1: 5 n2: 3
Magnification m1: 1/31.0 m2: 1/54.3

| “ith” | | di | ni | di | ni |
|---|---|---|---|---|---|
| surface | ri | (407 nm) | (407 nm) | (655 nm) | (655 nm) |
| 0 | | −90.00 | | −166.02 | |
| 1 | ∞ | 0.01 | | 0.01 | |
| (Aperture | | (φ3.964 | | (φ3.964 | |
| diameter) | | mm) | | mm) | |
| 2 | 1.92355 | 1.65000 | 1.559806 | 1.65000 | 1.540725 |
| 2′ | 1.98118 | 0.00583 | 1.559806 | 0.00583 | 1.540725 |
| 3 | −16.03440 | 1.55 | 1.0 | 1.67 | 1.0 |
| 3′ | −13.18912 | 0.00000 | 1.0 | 0.00000 | 1.0 |
| 4 | ∞ | 0.6 | 1.61869 | 0.6 | 1.57752 |
| 5 | ∞ | | | | |

Note:
“di” is the displacement from the “ith” surface to the “(i + 1)th” surface
“d2′” and “d3′” respectively express the displacement from surface 2 to surface 2′ and from surface 3 to surface 3′, respectively.

TABLE 3

Aspherical data
Surface 2
(0 < h ≦ 1.662 mm)
Aspherical coefficient
κ = −4.4662 × E−1
A1 = +8.7126 × E−4
A2 = −1.9063 × E−3
A3 = +9.2646 × E−4
A4 = −2.1198 × E−4
A5 = +1.6273 × E−7
A6 = +1.3793 × E−6
Optical path difference
function (blazed wavelength λB =
0.1 mm)
C2 = −2.3141 × E−1
C4 = −2.0141 × E−2
C6 = −7.5021 × E−3
C8 = +1.3559 × E−3
C10 = −4.0867 × E−4
Surface 2′ (1.662 mm < h)
Aspherical coefficient
κ = −4.1961 × E−1
A1 = +3.0725 × E−3
A2 = −2.5861 × E−3
A3 = +9.6551 × E−4
A4 = −1.3826 × E−4
A5 = +7.5482 × E−6
A6 = −7.5795 × E−7
Optical path difference
function (blazed wavelength λ_{B} =
0.1 mm)
C2 = −5.4710 × E−1
C4 = −2.6404 × E−2
C6 = −1.5524 × E−2
C8 = −1.0308 × E−3
C10 = +1.1379 × E−3
Surface 3
(0 < h ≦ 1.362 mm)
Aspherical coefficient
κ = −8.0653 × E+2
A1 = −5.5926 × E−3
A2 = +1.1660 × E−2
A3 = −6.4291 × E−3
A4 = +1.5528 × E−3
A5 = −1.3029 × E−4
A6 = −3.4460 × E−6
Surface 3′ (1.362 mm < h)
Aspherical coefficient
κ = −1.2782 × E+3
A1 = −7.3881 × E−3
A2 = +1.1800 × E−2
A3 = −6.0862 × E−3
A4 = +1.6068 × E−3
A5 = −2.3565 × E−4
A6 = +1.5370 × E−5

1. An optical pickup apparatus comprising:
a first light source to emit a light flux with a wavelength λ1;
a second light source to emit a light flux with a wavelength λ2 (λ1<λ2);
a coupling lens placed in a common light path through which pass said first light flux and said second light flux;
a first objective optical element provided with an optical surface consisting of a refractive surface;
a second objective optical element provided with an optical surface consisting of a refractive surface;
wherein said first light flux with the wavelength λ1 emitted from the first light source can pass through the coupling lens, can be converged by the first objective optical element, and can form a converged light spot on an information recording surface of a first optical information recording medium with a protective substrate thickness of t1, and the first light flux of the wavelength λ1 emitted from the first light source can pass through the coupling lens, can be converged by the second objective optical element, and can form a converged light spot on an information recording surface of a second optical information recording medium with a protective substrate thickness of t2 (t2>t1), and also, said second light flux with the wavelength λ2 emitted from the second light source can pass through the coupling lens, can be converged by the second objective optical element, and can form a converged light spot on the information recording surface of a third optical information recording medium with a protective substrate thickness of t3 (0.9t2≦t3≦1.1t2) and also has a larger track pitch than the second information recording medium;
wherein the coupling lens can be displaced in at least three positions in a direction of an optical axis, where the first position is a position of forming a converged light spot on the information recording surface of the first optical information recording medium using said first light flux via the first objective optical element, the second position is a position of forming a converged light spot on the information recording surface of the second optical information recording medium using said first light flux via the second objective optical element, and the third position is a position of forming a converged light spot on the information recording surface of the third optical information recording medium using said second light flux via the second objective optical element; and
wherein when a parallel light flux with a wavelength λ3 (1.7λ1≦λ3≦2.3λ1) is made to be incident on the second objective optical element, the wavefront aberration is 0.07λ3rms or more in the converged light spot formed on an information recording surface of a fourth optical information recording medium with a protective substrate thickness of t4 (t4>t3) and also has a larger track pitch than the third information recording medium.

2. The optical pickup apparatus according to claim 1, wherein at least one among the first to the third optical information recording medium has a plurality of information recording surfaces, and the coupling lens, according to the information recording surface on which light is converged by the objective optical element, is displaced in the direction of the optical axis.

3. An optical pickup apparatus comprising:
a first light source to emit a light flux with a wavelength λ1;
a second light source to emit a light flux with a wavelength λ2 (λ1<λ2);
a coupling lens that is placed in a common light path through which pass said first light flux and said second light flux and that is provided with a diffraction structure with an emission angle when the light flux with the wavelength λ1 is passed is different from the emission angle when the light flux with the wavelength λ2 is passed;
an aberration correction mechanism that is placed in the common light path and that makes the amount of spherical aberration when the light flux with the wavelength λ1 is passed different from the amount of spherical aberration when the light flux with the wavelength λ2 is passed;
a first objective optical element provided with an optical surface consisting of a refracting surface;
a second objective optical element provided with an optical surface consisting of a refractive surface;
wherein said first light flux with the wavelength λ1 emitted from the first light source can pass through the coupling lens and the aberration correction mechanism, can be converged by the first objective optical element, and can form a converged light spot on an information recording surface of a first optical information recording medium with a protective substrate thickness of t1, and the first light flux with the wavelength λ1 emitted from the first light source can pass through the coupling lens and the aberration correction mechanism, can be converged by the second objective optical element, and can form a converged light spot on an information recording surface of a second optical information recording medium with a protective substrate thickness of t2 (t2>t1), and also, said second light flux with the wavelength λ2 emitted from the second light source can pass through the coupling lens and the aberration correction mechanism, can be converged by the second objective optical element, and can form a converged light spot on an information recording surface of a third optical information recording medium with a protective substrate thickness of t3 (0.9t2≦t3≦1.1t2) and also has a larger track pitch than the second information recording medium;
wherein in the light flux that has passed through the coupling lens and the aberration correction mechanism can be given at least one among—a first aberration state suitable for forming a converged light spot on the information recording surface of the first optical information recording medium using said first light flux via the first objective optical element, a second aberration state suitable for forming a converged light spot on the information recording surface of the second optical information recording medium using said first light flux via the second objective optical element, and a third aberration state suitable for forming a converged light spot on the information recording surface of the third optical information recording medium using said second light flux via the second objective optical element; and
wherein, when a parallel light flux with a wavelength λ3 (1.7λ1≦λ3≦2.3λ1) is made to be incident on the second objective optical element, the wavefront aberration is 0.07λ3rms or more in a converged light spot formed on an information recording surface of a fourth optical information recording medium that has a protective substrate thickness of t4 (t4>t3) and also has a larger track pitch than the third information recording medium.

4. An optical pickup apparatus comprising:
a first light source to emit a light flux with a wavelength λ1;
a second light source to emit a light flux with a wavelength λ2 (λ1<λ2);
a coupling lens that is placed in the common light path through which pass said first light flux and said second light flux;
an aberration correction mechanism that is placed in the common optical path and that makes an amount of spherical aberration when a light flux with the wavelength λ1 is passed different from an amount of spherical aberration when a light flux with the wavelength λ2 is passed;
a first objective optical element provided with an optical surface consisting of a refractive surface;
a second objective optical element provided with an optical surface having a diffraction structure in which the emission angle when a light flux with the wavelength λ1 is passed is different from the emission angle when a light flux with the wavelength λ2 is passed;
wherein said first light flux with the wavelength λ1 emitted from the first light source can pass through the coupling lens and the aberration correction mechanism, can be converged by the first objective optical element, and can form a converged light spot on an information recording surface of a first optical information recording medium with a protective substrate thickness of t1, and further the first light flux with the wavelength λ1 emitted from the first light source can pass through the coupling lens and the aberration correction mechanism, can be converged by the second objective optical element, and can form a converged light spot on the information recording surface of a second optical information recording medium with a protective substrate thickness of t2 (t2>t1), and also, said second light flux with the wavelength λ2 emitted from the second light source can pass through the coupling lens and the aberration correction mechanism, can be converged by the second objective optical element, and can form a converged light spot on an information recording surface of a third optical information recording medium with a protective substrate thickness of t3 (0.9t2≦t3≦1.1t2) and also has a larger track pitch than the second information recording medium;
wherein in the light flux that has passed through the coupling lens and the aberration correction mechanism can be given at least one among—a first aberration state suitable for forming a converged light spot on the information recording surface of the first optical information recording medium using said first light flux via the first objective optical element, a second aberration state suitable for forming a converged light spot on the information recording surface of the second optical information recording medium using said first light flux via the second objective optical element, and a third aberration state suitable for forming a converged light spot on the information recording surface of the third optical information recording medium using said second light flux via the second objective optical element; and
wherein when a parallel light flux with a wavelength λ3 (1.7λ1≦λ3≦2.3λ1) is made to be incident on the second objective optical element, the wavefront aberration is 0.07λ3rms or more in the converged light spot formed on an information recording surface of a fourth optical information recording medium that has a protective substrate thickness of t4 (t4>t3) and also has a larger track pitch than the third information recording medium.

5. The optical pickup apparatus according to claim 3, wherein the aberration correction mechanism includes a section that displaces the coupling lens in the direction of the optical axis.

6. The optical pickup apparatus according to claim 4, wherein at least one of the first to the third optical information recording medium has a plurality of information recording surfaces, and the coupling lens is displaced in the direction of the optical axis in accordance with the information recording surface on which light is converged by the objective optical element.

7. The optical pickup apparatus according to claim 3, wherein the aberration correction mechanism includes a liquid crystal element.

8. An optical pickup apparatus according to claim 7, wherein at least one of the first to the third optical information recording medium has a plurality of information recording surfaces, and the liquid crystal element is driven so as to apply a different aberration state to the spot on the information recording surface on which light is converged by the objective optical element.

9. The optical pickup apparatus according to claim 1, wherein the refractive surface of the second objective optical element has been optimized for carrying out recording and/or reproduction of information for the second optical information recording medium.

10. The optical pickup apparatus according to claim 1, wherein the refractive surface of the second objective optical element has been optimized for carrying out recording and/or reproduction of information for the third optical information recording medium.

11. The optical pickup apparatus according to claim 1, wherein the refractive surface of the second objective optical element has been optimized for carrying out recording and/or reproduction of information for a hypothetical optical information recording medium different from the second optical information recording medium and from the third optical information recording medium.

12. The optical pickup apparatus according to claim 1, wherein either one of the first objective optical element and the second objective optical element can be inserted selectively in the common optical path.

13. The optical pickup apparatus according to claim 1, wherein a light flux with the wavelength λ1 is incident on any one of the first objective optical element and the second objective optical element using a switching element placed in the common optical path.

14. The optical pickup apparatus according to claim 1, wherein the coupling lens is a beam expander or a collimator lens.

15. The optical pickup apparatus according to claim 3, wherein when a light flux with wavelength λ1 passes through the diffraction structure, the intensity of the second order diffracted light becomes the highest, and when a light flux with the wavelength λ2 passes through the diffraction structure, the intensity of the first order diffracted light becomes the highest.

16. The optical pickup apparatus according to claim 3, wherein when a light flux with the wavelength λ1 passes through the diffraction structure, the intensity of the zero order diffracted light becomes the highest, and when a light flux with the wavelength λ2 passes through the diffraction structure, the intensity of the first order diffracted light becomes the highest.

17. The optical pickup apparatus according to claim 1, wherein the track pitch TP1 in the information recording surface of the first optical information recording medium, the track pitch TP2 in the information recording surface of the second optical information recording medium, and the track pitch TP3 in the information recording surface of the third optical information recording medium satisfy the following relationship:
TP1<TP2<TP3 (1)

18. The optical pickup apparatus according to claim 1, wherein the reflected light from the information recording surface of the first to the third optical information recording medium enters a common optical detector.

19. The optical pickup apparatus according to claim 1, wherein at least one of the first objective optical element and the second objective optical element is made of glass.
